(19) United States
(12) Patent Application Publication
(10) Pub. No.: US 2018/0176144 A1
(43) Pub. Date: Jun. 21, 2018

(54) APPARATUS FOR SELF-REGULATER (SR) LAST-IN, FIRST-OUT (LIFO) SCHEDULING IN SOFTWARE DEFINED NETWORKS (SNDs) WITH HYBRID TRAFFIC

(71) Applicant: Futurewei Technologies, Inc., Plano, TX (US)

(72) Inventors: Min Luo, San Jose, CA (US); Shih-Chun Lin, Alpharetta, GA (US); Ian F. Akyildiz, Alpharetta, GA (US)

(73) Assignee: Futurewei Technologies, Inc., Plano, TX (US)

(21) Appl. No.: 15/383,905

(22) Filed: Dec. 19, 2016

(51) Int. Cl. H04L 12/863; H04L 12/933; H04L 12/875

(52) U.S. Cl. CPC H04L 47/6245; H04L 47/56; H04L 49/10

(57) ABSTRACT

An apparatus, such as a network element, comprises a receiver to receive a plurality of packets from a plurality of traffic flows and a first non-transitory memory to form a first and second set of queues to store the plurality of packets from the plurality of traffic flows. One or more processors execute instructions stored in a second non-transitory memory to limit a rate of transfer of the plurality of packets that is output from the first set of queues to the second set of queues having a plurality of delays. A packet stored in the second set of queues is selected to be output based on a comparison of the plurality of delays.

### BACKGROUND

Modern communication networks support highly heterogeneous traffic, which may include movie downloading, messaging, file transfer, web traffic, and interactive traffic. Different types of traffic may have different traffic patterns and different requirements and constraints on network resources. A scheduler is commonly employed to schedule multiple flows for transmission over a specific transmission bandwidth. Network performance relies heavily on the performance of the scheduler.

### SUMMARY

In a first embodiment, the present technology relates to an apparatus that comprises a receiver to receive a plurality of packets from a plurality of traffic flows and a first non-transitory memory to form a first and second set of queues to store the plurality of packets from the plurality of traffic flows. One or more processors execute instructions stored in a second non-transitory memory to limit a rate of transfer of the plurality of packets that is output from the first set of queues to the second set of queues having a plurality of delays. A packet stored in the second set of queues is selected to be output based on a comparison of the plurality of delays.

A second embodiment in accordance with the first embodiment, wherein select the packet includes determine a plurality of head-of-line (HoL) delays for the second set of queues. A HoL delay in the plurality of HoL delays is a time duration between an arrival time and a transmission time of the packet in each queue of the second set of queues. A plurality of scheduling weights is set to the plurality of HoL delays.

A third embodiment in accordance with the first through the second embodiments, wherein select the packet includes compare the plurality of scheduling weights for the second set of queues to select the packet from a queue having a largest delay.

A fourth embodiment in accordance with the first through the third embodiments, wherein the queue is last-in, first-out (LIFO) queue in which the packet is a latest packet stored in the LIFO queue.

A fifth embodiment in accordance with the first through the fourth embodiments, wherein the plurality of traffic flows include light-tailed traffic flows and heavy-tailed traffic flows, wherein the light-tailed traffic flows and heavy-tailed traffic flows have bounded delays, and wherein the apparatus is included in a cellular network.

A sixth embodiment in accordance with the first though the fifth embodiments, further comprising a network controller coupled to a rate limiter. The rate limiter limits the rate of transfer of the plurality of packets output from the first set of queues to the second set of queues in response to a control signal from the network controller.

A seventh embodiment in accordance with the first though the sixth embodiments, further comprising a switch fabric to receive the packet from the rate limiter.

An eighth embodiment in accordance with the first though the seventh embodiments, wherein the first set of queues and the rate limiter is included in a first node of a multi-hop software-defined network. The second set of queues is included in a second node of the multi-hop software-defined network. A transmitter outputs the packet to a destination in the multi-hop software-defined network.

In a ninth embodiment, an apparatus in a cellular network comprises a receiver to receive a plurality of packets from a plurality of traffic flows and a first non-transitory memory to form a first and second set of queues to store the plurality of packets from the plurality of traffic flows. The plurality of traffic flows include light-tailed traffic flows and heavy-tailed traffic flows. The light-tailed traffic flows and heavy-tailed traffic flows have bounded delays. One or more processors execute instructions stored in a second non-transitory memory to limit a rate of transfer of the plurality of packets that is output from the first set of queues to the second set of queues having a plurality of delays. A packet stored in the second set of queues is selected to be output based on a comparison of the plurality of delays. Selecting the packet to be output includes determining a plurality of head-of-line (HoL) delays for the second set of queues. A HoL delay in the plurality of HoL delays is a time duration between an arrival time and a transmission time of the packet in each queue of the second set of queues. A plurality of scheduling weights is set to the plurality of HoL delays. Selecting the packet to be output also includes comparing the plurality of scheduling weights for the second set of queues to select the packet from a queue having a largest delay. A network controller is coupled to a rate limiter that limits the rate of transfer of the plurality of packets output from the first set of queues to the second set of queues in response to a control signal from the network controller.

In a tenth embodiment, an apparatus comprises a receiver to receive a plurality of packets from a plurality of traffic flows and a first non-transitory memory to form a first and second set of queues to store the plurality of packets from the plurality of traffic flows. One or more processors execute instructions stored in a second non-transitory memory to limit a rate of transfer of the plurality of packets that is output from the first set of queues to the second set of queues having a plurality of delays. A packet stored in the second set of queues is selected to be output based on a comparison of the plurality of delays. A first set of queues and a rate limiter is included in a first node of a multi-hop software-defined network. A switch fabric receives the packet from the rate limiter. The second set of queues is included in a second node of the multi-hop software-defined network. A transmitter outputs the packet to a destination in the multi-hop software-defined network.

In an eleventh embodiment, the present technology relates to a computer-implemented method to schedule a plurality of packets from a plurality of traffic flows. The method comprises storing the plurality of packets in a first set of queues. The plurality of packets is routed to a second set of queues. A plurality of head-of-line (HoL) delays for the plurality of packets stored in the second set of queues is determined and a plurality of weights is assigned to the second set of queues based on the plurality of head-of-line delays. The plurality of weights is compared to select a queue in the second set of queues to select a packet from to output. A sequential storage order of the plurality of packets stored in the queue is determined. The packet in the queue is selected to output based on a determination of the sequential storage order of the plurality of packets.

In a twelfth embodiment, a computer-implemented method schedules a plurality of packets from a plurality of traffic flows that include a light-tailed traffic flow and a heavy-tailed traffic flow. The method comprises storing the plurality of packets in a first set of queues. The plurality of packets is routed to a second set of queues. A rate of transfer of the plurality of packets from the first set of queues to the second set of queues is limited in response to a control signal. A plurality of head-of-line (HoL) delays for the plurality of packets stored in the second set of queues is determined and a plurality of weights is assigned to the second set of queues based on the plurality of head-of-line delays. The plurality of weights is compared to select a queue in the second set of queues to select a packet from to output. A sequential storage order of the plurality of packets stored in the queue is determined. The packet in the queue is selected to output based on a determination of the sequential storage order of the plurality of packets.

In a thirteenth embodiment, a packet scheduler schedules a plurality of packets from a plurality of traffic flows. The packet scheduler comprises storage to store the plurality of packets in a first set of queues. A router routes the plurality of packets to a second set of queues. A delay component determines a plurality of head-of-line (HoL) delays for the plurality of packets stored in the second set of queues. An assign component assigns a plurality of weights to the second set of queues based on the plurality of head-of-line delays. A compare component compares the plurality of weights to select a queue in the second set of queues to select a packet from to output. A determine component determines a sequential storage order of the plurality of packets stored in the selected queue. A select component selects the packet in the selected queue to output based on a determination of the sequential storage order of the plurality of packets in the selected queue.

In a fourteenth embodiment, the present technology relates to a non-transitory computer-readable medium storing computer instructions, that when executed by one or more processors, cause the one or more processors to perform steps. The steps include receive a plurality of packets from a light-tailed traffic flow and a heavy-tailed traffic flow. The plurality of packets is stored in a first set of queues. A rate of transfer of the plurality of packets is limited from the first set of queues to a second set of queues. A plurality of head-of-line (HoL) delays for the plurality of packets stored in the second set of queues is determined. A plurality of weights is assigned to the second set of queues based on the plurality of head-of-line delays. The plurality of weights is compared to select a queue in the second set of queues to select a packet from to output. A sequential storage order of the plurality of packets stored in the queue is determined. The packet in the queue is selected to output based on the sequential storage order of the plurality of packets.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is block diagram that illustrates a network that implements a self-regulated (SR) last-in, first-out (LIFO) delay-based maximum weight scheduling (DMWS) according to embodiments of the present technology.

FIG. 2A illustrates a switch according to embodiments of the present technology.

FIG. 2B illustrates an equation for a LIFO-DMWS policy according to embodiments of the present technology.

FIG. 3 illustrates equations for a SR-LIFO policy according to embodiment of the present technology.

FIG. 4 illustrates a rate limiter used with a switch fabric according to embodiments of the present technology.

FIG. 5 illustrates a rate limiter used in multi-hop network topology according to embodiments of the present technology.

FIG. 6 illustrates a network element according to embodiments of the present technology.

FIG. 7 illustrates another network element according to embodiments of the present technology.

FIG. 8 is a flowchart that illustrates a method of operating a network according to embodiments of the present technology.

FIG. 9 is a flowchart that illustrate a method of operating a network including a controller and switches according to embodiments of the present technology.

FIG. 10 is a flowchart that illustrate a method of operating a network having SR-LIFO-DMWS policy according to embodiments of the present technology.

FIG. 11 is a flowchart that illustrate a method of scheduling a plurality of packets according to embodiments of the present technology.

FIG. 12 is a flowchart that illustrate a method of scheduling a plurality of packets using a LIFO-DMWS policy according to embodiments of the present technology.

FIG. 13 is a flowchart that illustrates a method of scheduling a plurality of packets in a hybrid heavy-tailed/light-tailed (HT/LT) network according to embodiments of the present technology.

FIGS. 14A-B are graphs that illustrate scheduling a HT traffic flow and LT traffic flow according to embodiments of the present technology.

FIGS. 15A-B are graphs that illustrate scheduling two HT traffic flows and a LT traffic flow according to embodiments of the present technology.

FIG. 16A illustrates a linear network topology having three traffic flows according to embodiments of the present technology.

FIG. 16B is a graph that illustrates a comparison between back-pressure (BP) routing and using a scheduler according to embodiments of the present technology.

FIG. 17 is a block diagram of a packet scheduler according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology generally relates to a policy for scheduling packets in a network, such as a software-designed network, that transfers hybrid traffic flows, such as light-tailed (LT) traffic flows and heavy-tailed (HT) traffic flows. Throughput-optimal scheduling is provided by using a delay-based maximum-weight (DMWS) scheduling policy with a last-in first-out (LIFO) service discipline, as LIFO-DMWS. Self-regulated (SR) switches may enable network stability for congestion-free networks without the use of typical signaling, as SR-LIFO-DMWS.

Network traffic may include a combination of HT traffic flows and LT traffic flows. HT refers to a process with a tail distribution that decays slower than an exponential distribution in an embodiment. An HT traffic flow carries a large volume of traffic, but the traffic occurs infrequently. Thus, HT traffic flow may comprise characteristics of a long-range dependent (LRD) process. For example, a user may generate occasional file or movie download requests with large file sizes. Conversely, LT refers to a process with a tail distribution that decays faster than or equal to an exponential distribution in an embodiment. An LT flow carries a small volume of traffic, but the traffic occurs frequently. For example, a user may send frequent messages and emails that carry a small amount of data. Disclosed herein are embodiments of an adaptive traffic-aware SR-LIFO-DMWS policy that provides optimal throughput for both HT traffic flow and LT traffic flow in a hybrid HT/LT network.

Scheduling is one of the most important resource allocations for networks, or networked systems. Typical scheduling policies are developed under LT traffic flow assumptions. However, HT traffic flows may be included in a variety of networked systems, such as cellular networks, the Internet, and data centers. The highly bursty nature of HT traffic flows may challenge the applicability of typical scheduling policies (such as, maximum-weight/back-pressure (BP) polices). A SR-LIFO-DMWS policy or scheduler is provided to enable throughput optimality under hybrid HT and LT traffic flows in embodiments. The throughput optimality of a SR-LIFO-DMWS policy enables a networked system to support the largest set of incoming traffic flows, while ensuring bounded queueing delay to each queue, no matter whether the queue has HT or LT traffic flow arrival in embodiments. In particular, by exploiting asymptotic queueing analysis, a SR-LIFO-DMWS policy may achieve throughout optimality without requiring knowledge of traffic statistic information (e.g., the tailness or burstiness of traffic flows). A SR-LIFO-DMWS policy may further ensure network stability by reducing or eliminating congestion without typical signaling in embodiments.

A maximum-weight scheduling (MWS) policy (or many of its variants) may be used to achieve strong stability for LT traffic flows (such as a Markovian or Poisson traffic flow). A MWS policy may enable that each LT traffic flow has a bounded average queueing delay whenever the incoming traffic rates are within the network stability region. However, a network may also include HT traffic flows as well as LT traffic flows. HT traffic flows may be mainly caused by the inherent heavy-tailed distribution in traffic sources (such as a file size on the Internet servers, a message size on cellular base stations, a flow length of data centers, and a frame length of variable bit rate (VBR) video streams).

Different from typical LT traffic flows, HT traffic flows exhibit high burstiness or dependence over a long range of time scale. Such a highly bursty nature may induce significant degradation in network stability, thus having a destructive impact on the throughput optimality of scheduling policies. In particular, MWS policies may not be throughput-optimal in the presence of HT traffic flows because MWS may lead to unbounded average queueing delay even when the arrival traffic rates are within network capacity region. The queues with HT traffic flow arrivals (HT queues) may inherently experience heavy-tail distributed queueing delay, which implies that HT queues have much higher chance to experience very large queueing delay, compared with the queues with LT arrivals (LT queues). As a result, based on MWS policies, HT queues may receive much more service opportunities, while LT queues are starved for scheduling service and their queueing delay may be of unbounded mean.

Maximum power weight scheduling policies (MPWS) may be used, which make scheduling decisions based on queue backlog raised up to the α^{th} power, where α is determined by the burstiness or heavy tailness of traffic flows. Intuitively, by properly selecting α to allocate more service opportunities to LT queues, MPWS may ensure that all LT queues experience bounded average queueing delay, completely shielding those LT queues from the destructive impact of HT traffic. However, MPWS may not ensure the delay boundness of the HT queues and thus may not be a throughput-optimal scheduling policy. Moreover, MPWS policy requires the statistical information (i.e., tailness or burstiness of arrival flows), which may be difficult to estimate.

LIFO-DMWS or SR-LIFO-DMWS policies are provided that enables throughput optimality in the presence of HT traffic flows. In particular, rather than adopting queue backlog as link weight, delay-based scheduling is used, which exploits the head-of-line (HoL) delay metric in inter-queue scheduling decisions (i.e., determining the serving order for the packets from different queues). Moreover, instead of using a typical first-in, first-out (FIFO) service discipline, a LIFO service discipline for intra-queue scheduling (i.e., determining the serving order for the packets within each queue). Furthermore, by exploiting asymptotic queueing delay analysis along with moment theory, a LIFO-DMWS policy may be throughput-optimal with respect to strong stability in the presence of heavy tails. That is, a LIFO-DMWS policy, no matter whether the incoming traffic flows are HT or LT, all queues will experience bounded average queueing delay as long as the incoming traffic rates are within the network capacity region. Such a throughput optimality feature may be of great importance, since it prevents the quality of service (QoS) performance of LT traffic from being significantly degraded by the bursty HT traffic.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the detailed description, numerous specific details are set forth in order to provide a thorough understanding of the technology. However, it will be clear that the technology may be practiced without such specific details.

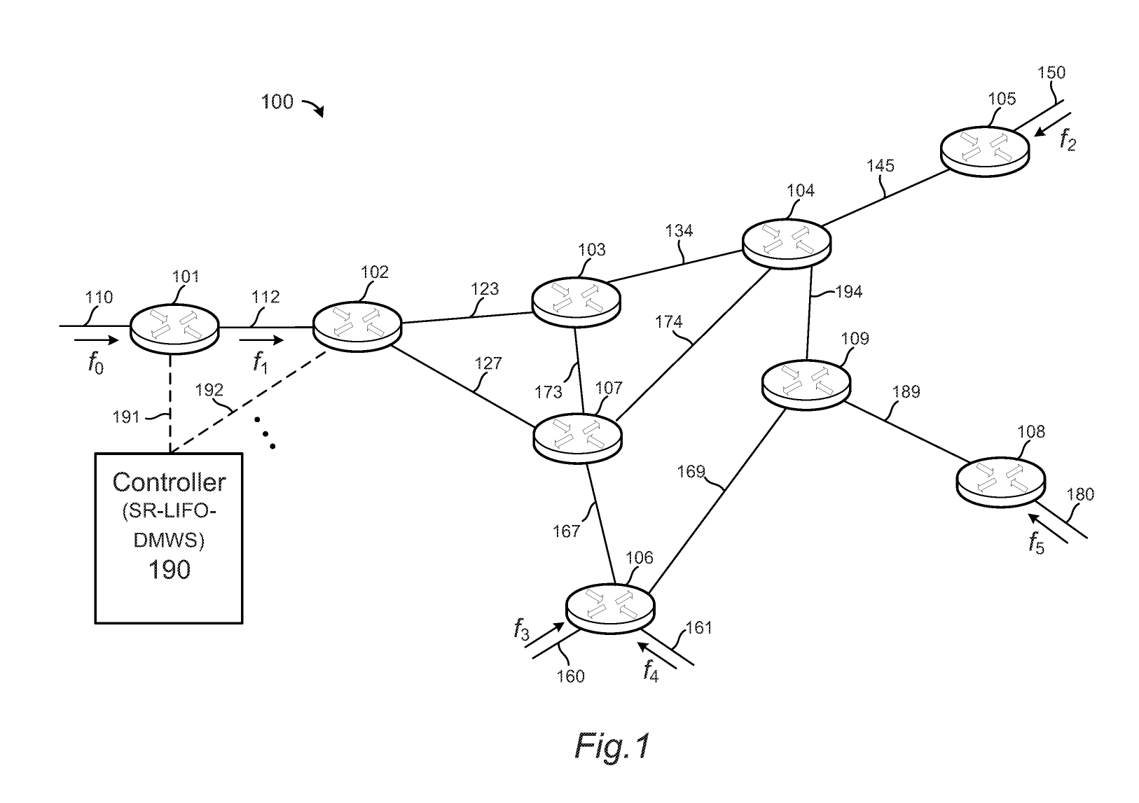

FIG. 1 is a schematic diagram of an embodiment of a network 100 that includes a plurality of nodes and links as well as a controller. The plurality of nodes 101-109 may be interconnected by a plurality of links. Signals or traffic flows f₀-f₅ that may include HT and LT traffic flows are transferred to and from nodes in network 100 via the plurality of links, such as traffic flow f₁ transferred between nodes 101 and 102 by link 112. A particular traffic flow may include a plurality of packets and a link may include a particular signal path between two or more nodes. In an embodiment, controller 190 and the plurality of nodes 101-109 employs a SR-LIFO-DMWS or LIFO-DMWS policy for transferring packets between the plurality of nodes 101-109.

By employing SR-LIFO-DMWS or LIFO-DMWS policy at every node (or group of nodes) in a network 100, the disclosed embodiments provide a congestion free stable network without the need of typical signaling that achieves bounded delays for hybrid traffic.

In an embodiment, controller 190 includes an integrated circuit processor to execute instructions stored in non-volatile memory to perform a SR-LIFO-DMWS or LIFO-DMWS policy in network 100. In an embodiment, controller 190 may output control signals, such as an initial rate limiter value, to one or more nodes. Similarly as described herein, one or more nodes may include an integrated circuit processor to execute instructions stored in non-volatile memory to perform a SR-LIFO-DMWS or LIFO-DMWS policy.

In an embodiment, controller 190 outputs control signals to the plurality of nodes 101-109 via signal paths, such as signal paths 191-192 coupled to nodes 101 and 102. In an embodiment, controller 190 outputs control signals to links to configure signal paths between nodes.

The network 100 may be any types of network, such as an electrical network and/or an optical network. In embodiments, network 100 may comprise multiple networks having internal and external links. The disclosed embodiments may be employed in conjunction with any types of routing methods. The network 100 may employ any network communication protocols, such as transmission control protocol/Internet protocol (TCP/IP). The network 100 may further employ any types of network virtualization and/or network overlay technologies, such as SDN technologies and virtual extensible local area network (VXLAN) technologies. Network 100 may be a large-scale network, IP network, packet-switched network, centrally controlled SDN, cellular network, WiFi network (Institute of Electrical and Electronics Engineers' (IEEE) 802.11x)), satellite network, ad-hoc and sensor network or high-performance computing cluster (data center) network. In an embodiment, network 100 may include a multi-hop cellular network. The network 100 may operate under a single network administrative domain or multiple network administrative domains. The network 100 may interconnect with other networks. The links may comprise physical links, such as fiber optic links, electrical links, wireless links, and/or logical links used to transport data in the network 100.

In an embodiment, network 100 includes the following node/link architecture. Traffic flow f₀ is provided to node 101 via link 110. Traffic flow f₁ is provided from node 101 to node 102 via link 112. Node 102 is coupled to nodes 103 and 107 via links 123 and 127. Node 103 is coupled to node 107 via link 173. Node 103 is coupled to node 104 via link 134 and node 107 is coupled to node 104 via link 174. Node 104 is coupled to node 105 via link 145. Flow f₂ is input to node 105 via link 150. Node 109 is coupled node 104 via link 194. Node 109 is coupled to nodes 106 and 108 via links 169 and 189. Node 106 is coupled to node 107 via link 167. Flows f₃ and f₄ are input to node 106 via links 160 and 161. Flow f₅ is input to node 108 via link 180.

A node in the plurality of nodes 101-109 may be any network element or device, such as a router or switch (including switch fabric), configured to receive and forward data in a network 100. A network element may communicate with other network elements or other networks. As shown, a node may receive flows from other networks. The traffic flows or flows may be referred to as external flows or exogenous flows. Some of the flows may include HT traffic, while some other flows may include LT traffic. A node in the plurality of nodes 101-109 may employ a SR-LIFO-DMWS or LIFO-DMWS policy. A node may estimate delays associated with the flows and compute weighting factors according to the estimated delays. For example, a node queues packets of each flow in a separate queues and measures the HoL delay of each queue. The weighting factor of a flow is computed by associating it with HoL delay of the queue. A node serves the queue with the maximum weight delay in a LIFO service discipline without requiring typical signaling. For example, a node does not have to send or receive signals regarding traffic information that may include traffic classification and/or statistical information.

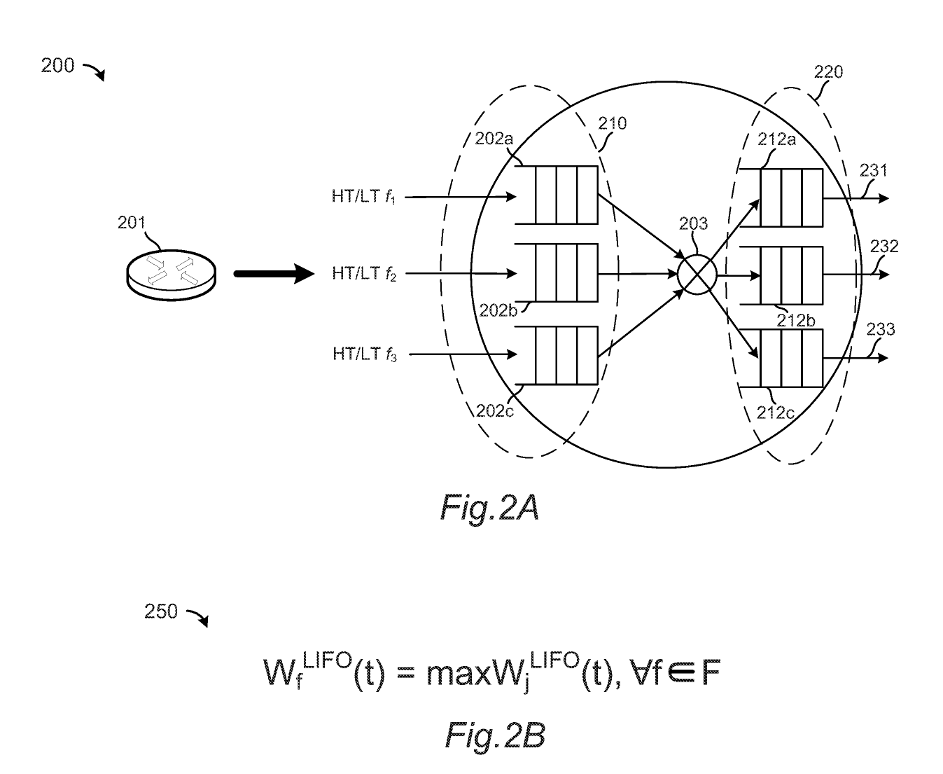

FIG. 2A illustrates a switch, such as a software-design (SD) switch 201, according to embodiments of the present technology. In embodiments, at least one SD switch 201 is used in network 100. SD switch 201 receives a plurality of traffic flows that may include HT and/or LT traffic flows f₁-f₃ having a plurality of packets that are routed to links (or signal paths) 231-233. In embodiments, links 231-233 correspond to one or more links illustrated in FIG. 1. SD switch 201 also includes at least two set of queues, such as input queues 202a-c and output queues 212a-c. A packet from a particular flow may be stored in input queues 202a-c then routed by output queues 212a-c via routing mechanism 203 based on a SR-LIFO-DMWS or LIFO-DMWS policy according to embodiments of the present technology.

Generally, input queues 202a-c may be considered intra-queues that are accessed using a LIFO service discipline and output queues 212a-c may be considered inter-queues accessed using a LIFO-DMWS policy. In particular, when traffic flows arrive, SD switch 201 has packets in traffic flows stored in input queues 202a-c and transferred out of input queues 202a-c to output queues 212a-c by outputting the last-in (stored) packet as the first-out (transferred) packet (LIFO service discipline or manner) to output queues 212a-c. Head-of-line (HoL) delays for output queues 212a-c are then estimated or determined. In an embodiment, a HoL delay is determined by measuring a time duration between an arrival time and a transmission time of a packet in each queue of the output queues 212a-c. In an embodiment, time stamps associated with the packets in output queues 212a-c are used to determine HoL delays. A maximum weight policy is used by associating scheduling weights for each of the output queues 212a-c based on HoL delays of each of the output queues 212a-c. The output queue with the largest scheduling weight (or largest HoL in an embodiment) is selected to be served in a LIFO service discipline—last stored packet is the first packet output—from the selected queue.

FIG. 2B illustrates an equation 250 of a SF-LIFO-DMWS or LIFO-DMWS policy in an embodiment of the present technology. In an embodiment, a queue f is served based on equation 250. In embodiments, a SF-LIFO-DMWS or LIFO-DMWS policy serves the latest stored packet from the queue having the largest delay among output queues 212a-c.

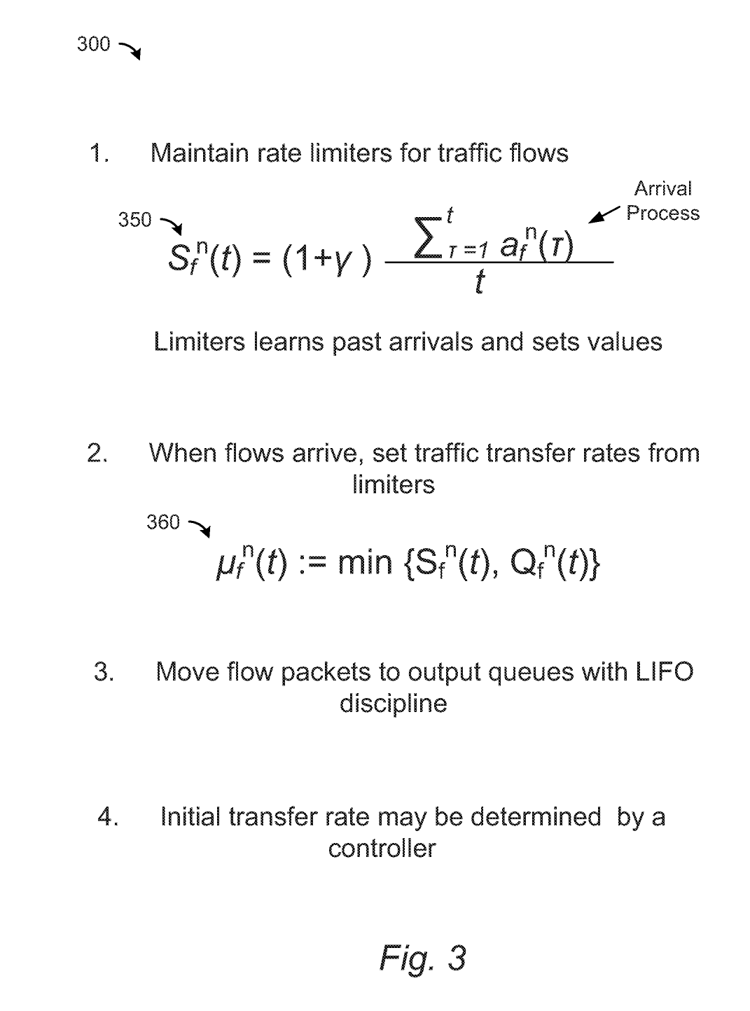

FIG. 3 illustrates limiting a transfer rate of packets, such as a SR-LIFO policy 300, to prevent congestion according to embodiments of the present technology. In an embodiment, a rate limiter may be used to control traffic rates so that a stage of a SR-LIFO-DMWS or LIFO-DMWS policy may serve all incoming traffic without congestion. In embodiments, a rate limiter may be centrally regulated. For example, a controller 190 may regulate (adjust a transfer rate) or initialize a rate limiter (set an initial transfer rate) in a switch, such as a SD switch, by outputting a control signal indicating initialization or regulation to the switch. In other embodiments, a controller 190 may output a control signal that indicates a fine tune adjustment or real-time adjustment to a switch. In still a further embodiment, a switch may self-regulate a transfer rate with or without a control signal from a controller.

In embodiments, SR-LIFO policy 300 includes maintaining a rate limiter for all incoming traffic flows to output queues. In an embodiment, a SF-LIFO policy also includes a rate estimator to estimate the transfer rate of packets. In an embodiment, SR-LIFO policy 300 uses equation 350 to estimate a transfer rate of packets at or in a node n. In particular, for each traffic flow f, node n maintains a transfer rate estimate S_{f}ⁿ(t), where a_{f}ⁿ(τ) denotes a number of packets deposited (or stored) in an input queue at a time-slot t and γ>0 is a constant to be set. In an embodiment, a controller by way of a control signal may set the constant. In an embodiment, a transfer rate estimate may be calculated using the number of packets output from an input queue to an output queue in a node.

When a traffic flow arrives, a traffic or packet transfer rate is set by a rate limiter using equation 360 in an embodiment. For example, at time t, node n moves μ_{f}ⁿ(t):=min {S_{f}ⁿ(t), Q_{f}ⁿ(t)} packets from an input queue to an output queue. Packets from traffic flows are transferred from input queues to output queues using a LIFO service discipline. Initial transfer rates of a rate limiter may be determined by a controller in an embodiment. In embodiments, a rate limiter learns from past arrivals and set a transfer rate accordingly.

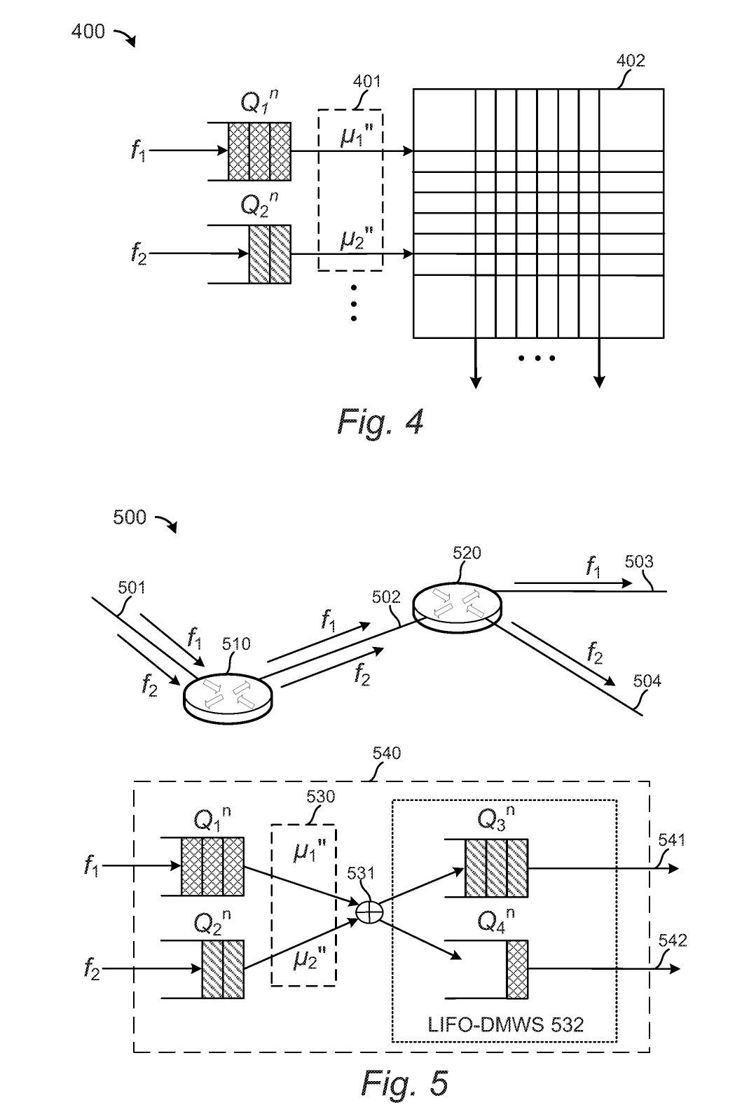

FIG. 4 illustrates a system 400 including a rate limiter 401 used with a switch fabric 402 according to embodiments of the present technology. In embodiments, system 400 represents a node in network 100. In embodiments, a plurality of traffic flows f₁-f₂ having a plurality of packets are stored in queues Q₁ⁿ-Q₂ⁿ, respectively. In an embodiment, the plurality of traffic flows f₁-f₂ include HT and LT traffic flows that arrive via a plurality of input links. In an embodiment, queues Q₁ⁿ-Q₂ⁿ may be input queues coupled to the plurality input links. Rate limiter 401 limits the rate of transfer (or service rate) of the packets μ₁ⁿ-μ₂ⁿ stored in queues Q₁ⁿ-Q₂ⁿ to switch fabric 402. In an embodiment, equation 360 illustrated in FIG. 3 is used to limit the rate of transfer of the packets μ₁ⁿ-μ₂ⁿ. In an alternate embodiment, another rate limiter method is used.

In an embodiments, packets μ₁ⁿ-μ₂ⁿ are selected to be transferred from queues Q₁ⁿ-Q₂ⁿ in a LIFO service discipline—first-in, first-out manner.

In an embodiment, system 400 includes a rate estimator to estimate the transfer rate of packets μ₁ⁿ-μ₂ⁿ between queues Q₁ⁿ-Q₂ⁿ and switch fabric 402 that may be included in rate limiter 401. In embodiments, a rate estimate S_{f}ⁿ(t) is performed using equation 350 shown in FIG. 3. In an alternate embodiment, another rate estimate method is used.

Rate limiter 401 is self-regulated and/or regulated by a controller, such as controller 190, in embodiments. In an embodiment, a control signal from a controller is provided to rate limiter 401 to initialize a transfer rate and/or adjust (fine tune) a transfer rate of rate limiter 401. Rate limiter 401 may be self-regulated or limit a transfer rate without information from a controller or without information from a controller after an initialization (receiving a control signal for initialization) by the controller in embodiments. A control signal may also provide rate limiter 401 with other control or initialization information, such as an initial rate of transfer.

In an embodiment, switch fabric 402 may include a plurality of crossbar switches coupled to a plurality of signal paths that form a matrix of crossbar switches. In an embodiment, a switch fabric 402 may be configured by a controller or configured (set particular crossbar switches to couple particular signal paths) in response to a control signal from a controller. In an embodiment, a switch fabric 402 may include a fibre channel switch fabric or an equivalent.

In an embodiments, packets μ₁ⁿ-μ₂ⁿ are input to switch fabric 402, via rate limiter 401 which may limit the rate of transfer, and output to links (external to the node in embodiments) in response to a routing configuration of switch fabric 402.

FIG. 5 illustrates a rate limiter used in a multi-hop network topology, such as a multi-hop network, according to embodiments of the present technology. In particular, system 500 illustrates a portion of a SDN having multi-hop nodes 510 and 520. In an embodiments, a plurality of traffic flows f₁-f₂ are input to node 510 via link 501 having two signal paths. Node 510 then outputs the plurality of traffic flows f₁-f₂ to node 520 via link 502 having two signal paths. Node 520 outputs the plurality of traffic flows f₁-f₂ via link 503 and 504, respectfully. In an embodiment, the plurality of traffic flows f₁-f₂ include HT and LT traffic flows having a plurality of packets. In an embodiment, nodes 510 and 520 corresponds to nodes 101 and 102 illustrated in FIG. 1. Similarly, links 541-542 correspond to links 123 and 127 in an embodiment.

System 540 illustrates queues Q₁ⁿ-Q₂ⁿ storing a plurality of packets from the plurality of traffic flows f₁-f₂, rate limiter 530, router 531 and queues Q₃ⁿ-Q₄ⁿ coupled to output links 541 and 542, respectively. In an embodiment, system 540 may be included in multi-hop nodes 510 and 520 (as two stages) or in a single node. In an embodiment, queues Q₁ⁿ-Q₂ⁿ and rate limiter 530 are included in node 510 and router 531 and queues Q₃ⁿ-Q₄ⁿ are included in node 520. In an embodiment, links 503-504 correspond to links 541-542.

Queues Q₁ⁿ-Q₂ⁿ and rate limiter 530 in system 540 operate similar to the queues and rate limiter 401 illustrated in FIG. 4. In particular, rate limiter 530 includes a rate estimator as described herein. Rate limiter 530 limits (and estimates) the rate of transfer of packets μ₁ⁿ-μ₂ⁿ from queues Q₁ⁿ-Q₂ⁿ to router 531. In an embodiment, packets μ₁ⁿ-μ₂ⁿ are transferred from node 510, and in particular rate limiter 530 via link 502 to router 531 in node 520.

Router 531 is responsible for routing packets μ₁ⁿ-μ₂ⁿ to the selected queues Q₃ⁿ-Q₄ⁿ, which may act as output queues for system 540. In an embodiments, a particular packet from a selected queue is output from queues Q₃ⁿ-Q₄ⁿ using a LIFO-DMWS policy as described herein. In an embodiment, a queue with the maximum scheduling weight is selected (after a comparison of the scheduling weights) and a packet that was stored mostly recently (of last-in) in a stack of packets is selected to be output (first-out) to a particular output link.

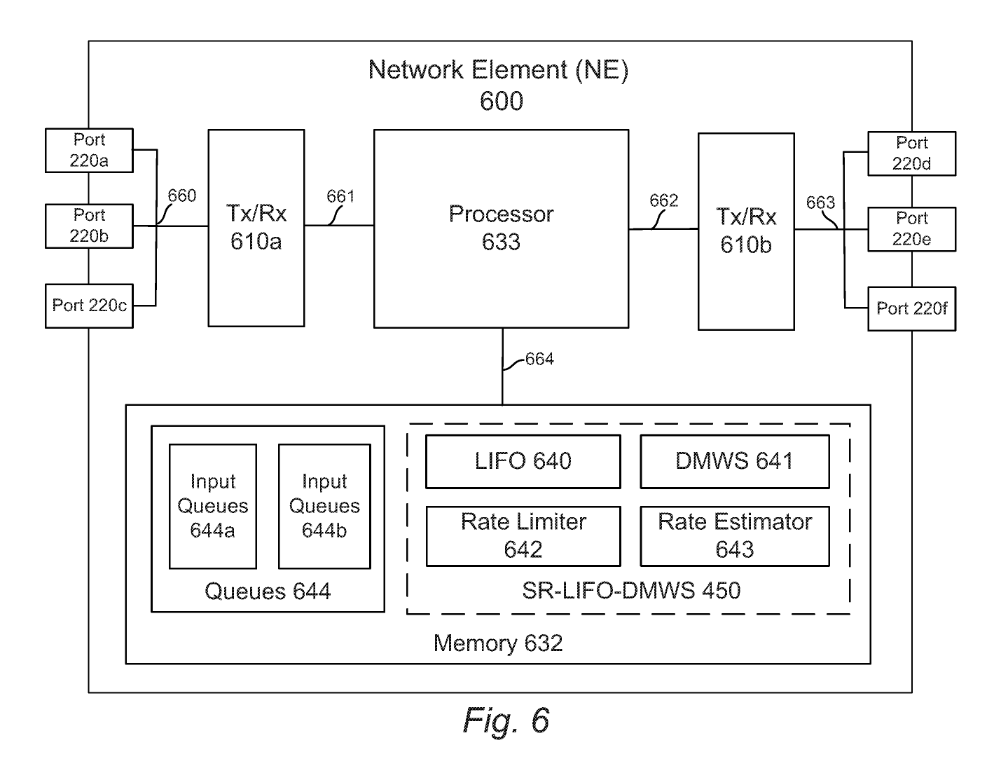

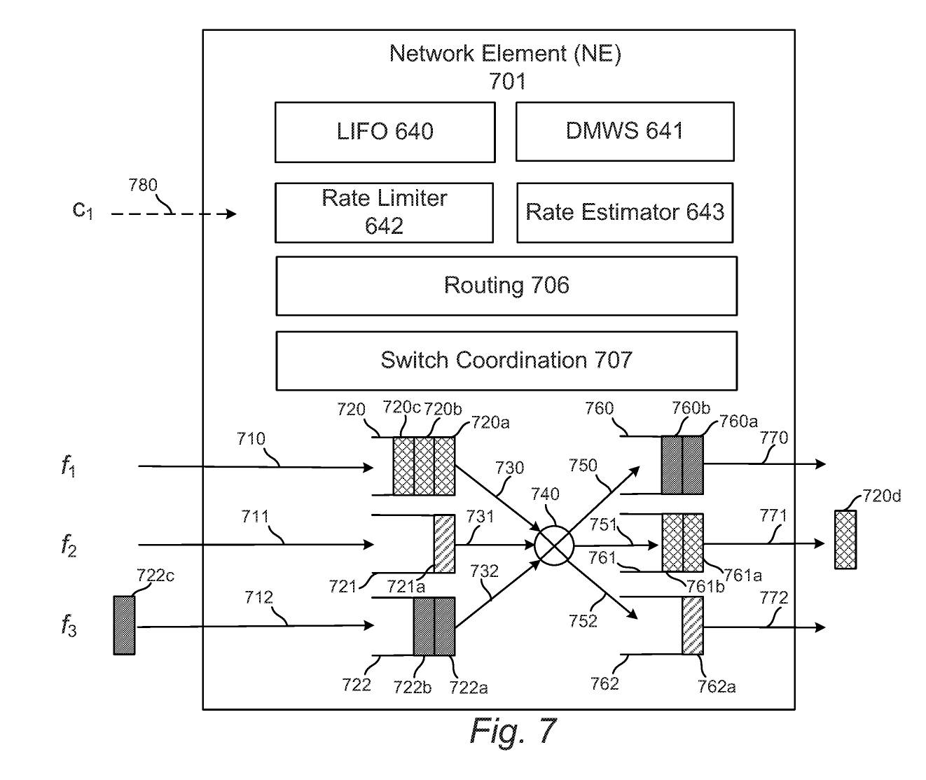

FIG. 6 is a block diagram of a network element 600, such as one of the nodes in the network 100. Network element 600 may be configured to implement and/or support a SR-LIFO-DMWS or LIFO-DMWS policy as described herein. Network element 600 may be implemented in a single node or the functionality of network element may be implemented in a plurality of nodes. One skilled in the art will recognize that the term network element encompasses a broad range of devices of which network node is merely an example. Network element 600, as well as network element 700 shown in FIG. 7, is included for purposes of clarity of discussion, but is in no way meant to limit the application of the present disclosure to a particular network element embodiment or class of network element embodiments.

At least some of the features/methods described in the disclosure are implemented in a network apparatus or component such as network element 600. For instance, the features/methods in the disclosure may be implemented using hardware, firmware, and/or software installed to run on hardware.

Network element 600 is any device that transports or transfers packets through a network in embodiment, such as a switch, router, bridge, firewall, server, a client, etc. As shown in FIG. 6, the network element 600 comprises transceivers (Tx/Rxs) 610a and 610b, which may be transmitters, receivers, or combinations thereof. The Tx/Rx 610a is coupled to a plurality of ports 620a-620c via signal path 660 for transmitting and/or receiving packets from other nodes via links. Tx/Rx 610a is coupled to processor 633 via signal path 661. Similarly, The Tx/Rx 610b is coupled to a plurality of ports 620d-620f via signal path 663 for transmitting and/or receiving packets from other nodes via links. Tx/Rx 610b is coupled to processor 633 via signal path 662.

A processor 633 is coupled to each Tx/Rxs 610a-b to process the packets and/or determine which nodes to send the packets to. In an embodiment, processor 633 may include one or more types of electronic processors having one or more cores. In an embodiment, processor 633 is an integrated circuit processor that executes (or reads) computer instructions that may be included in code and/or computer programs stored on a non-transitory memory to provide at least some of the functions described herein. In an embodiment, processor 633 is a multi-core processor capable of executing multiple threads. In an embodiment, processor 633 is a digital signal processor, baseband circuit, field programmable gate array, digital logic circuit and/or equivalent. In an embodiment, processor 633 may be part of one or more application specific integrated circuits (ASICs) and/or digital signal processors (DSPs).

Processor 633 communicates with memory 632 via signal path 664, such as reads instructions and transfers packets to and from queues 644. In an embodiment, signal path 664 may be a bus or interconnect to transfer signals between processor 633 and memory 632. Memory 632 may be a non-volatile memory that stores instructions as well as acts as a data store, cache, queue, buffer and/or equivalent

The processor 633 may execute a software component having instructions, such as SR-LIFO-DMWS 450, to perform a scheduling policy, as discussed more fully herein. In an embodiment, memory 632 also includes a plurality of queues 644 which may include a first set of input queues 644a and a second set of output queues 644b. In embodiments, processor 633 executes SR-LIFO-DMWS 450 to store and retrieve packets from queues 644 using a LIFO-DMWS policy. In an embodiment, processor 633 executes SR-LIFO-DMWS 450 to further provide a rate limiter and rate estimator for the transfer of packets from a set of input queues 644a. As such, the inclusion of the SR-LIFO-DMWS 450 and associated methods and systems provide improvements to the functionality of the network element 600. Further, the SR-LIFO-DMWS 450 effects a transformation of a particular article (such as a network element or network) to a different state.

Memory 632, as well as other memories described herein, may comprise any type of system memory such as static random access memory (SRAM), dynamic random access memory (DRAM), synchronous DRAM (SDRAM), read-only memory (ROM), a combination thereof, or the like. In an embodiment, a memory 632 may include ROM for use at boot-up, and DRAM for program and data storage for use while executing computer instructions. In embodiments, memory 632 is non-transitory or non-volatile integrated circuit memory storage. Similarly, storages described herein may be non-transitory or non-volatile integrated circuit memory storage.

Further, memory 632 may comprise any type of memory storage device configured to store data, store computer programs including instructions, and store other information and to make the data, computer programs, and other information accessible via signal path 664. Memory 632 may comprise, for example, one or more of a solid state drive, hard disk drive, magnetic disk drive, optical disk drive, and/or an equivalent.

In embodiments, SR-LIFO-DMWS 450 includes a plurality of software components, such as LIFO 640, DMWS 641, rate limiter 642 and rate estimator 643. In embodiments, software components may be embodied as a computer program, object, function, subroutine, method, software instance, script, a code fragment, stored in an electronic file, singly or in combination. In order to clearly describe the present technology, software components shown in FIG. 6 (as well as in FIG. 7) are described as individual software components. In embodiments, the software components illustrated, singly or in combination, may be stored (in single or distributed computer-readable storage medium(s)) and/or executed by a single or distributed computing device (processor or multi-core processor) architecture. Functions performed by the various software components described herein are exemplary. In other embodiments, software components identified herein may perform more or less functions. In embodiments, software components may be combined or further separated.

In embodiments, software components illustrated herein may be replaced with similar hardware components or logic/circuits which are configured to perform similar functions.

LIFO 640 is responsible for, among other functions, storing, maintaining and retrieving one or more packets in a LIFO service discipline. In an embodiment, the most recently stored packet in a queue or stack of packets is output first. In an embodiment, packets are stored, maintained and retrieved such that the last packet stored in a queue is also the first packet to be output. In an embodiment, LIFO 640 performs a portion of a LIFO-DMWS or SR-LIFO-DMWS policy in a network, such as a SDN.

DMWS 641 is responsible for, among other functions, delay-based maximum weight scheduling policy. In an embodiment, DMWS 641 is responsible for assigning scheduling weights to a plurality of queues. In an embodiment, the plurality of scheduling weights are set to the plurality of HoL delays associated with the plurality of queues. A HoL delay in a plurality of HoL delays is a time duration between an arrival time and a transmission time of a packet in a queue in an embodiment. In other embodiments, other time durations may be used. DMWS 641 is also responsible for comparing the plurality of scheduling weights associated with the plurality of queues to determine a maximum scheduling weight that identifies a selected queue to access a packet. In embodiments, other types of DMWS scheduling policies may be employed. In an embodiment, DMWS 641 performs a portion of a LIFO-DMWS or SR-LIFO-DMWS policy in a network.

Rate limiter 642 is responsible for, among other functions, limiting a rate of transfer (or service rate) of packets. In an embodiment, rate limiter 642 limits the rate of transfer (or service) from a first set of queues to a second set of queues. In embodiments, packets μ₁ⁿ-μ₂ⁿ are limited by a rate limiter, such as similarly to rate limiters 401 and/or 530 seen in FIGS. 4 and 5. In an embodiment, transfer rates of packets are limited per equation 360 in FIG. 3. In other embodiments, other methods for limiting a transfer of packets may be used to reduce the likelihood of congestion. In embodiments, rate limiter 642 is self-regulated or may be regulated by a controller.

Rate estimator 643 is responsible for, among other functions, estimating a transfer rate of packets in a traffic flow, such as a transfer rate of packets to a node or from a plurality of input queues in a node to another destination, such as a set of output queues. In an embodiment, a (transfer) rate estimate S_{f}ⁿ(t) is made using equation 350 in FIG. 3. In other embodiments, other methods for estimating transfer rates of packets may be used.

FIG. 7 is a block diagram of another embodiment of a network element 701 that implements a LIFO-DMWS or SR-LIFO-DMWS policy in a network, such as a SDN. Network element 701 is similar to network element 600 in having LIFO 640, DMWS 641, rate limiter 642 and/or rate estimator 643. Also similarly to network element 600, network element 701 receives hybrid traffic flows and may be considered a node in a SDN in embodiments. In addition, network element may include routing 706 and/or switch coordination 707 which may be a software and/or hardware component. In an embodiment, network element 701 does not include a component to calculate traffic statistics and/or identify traffic type as well as send that information to other network elements or nodes. Accordingly in an embodiment, signaling to other nodes in a network that identify traffic statistics and/or traffic type is not needed.

For clarity in describing the present technology, some typical components in a network element 701 are not shown in FIG. 7. For example, network element 701 may include an integrated circuit processor, memory to store software components, signal paths and/or interface circuits in embodiments. For example, a control signal C₁ may be provided to network element 701 by way of signal path 780 from a controller, such as controller 190 in an embodiment. In an embodiment, control signal C₁ may be input to an integrated circuit processor of network element 701 to control a particular state or operation of network element 701.

Network element 701 receives a plurality of traffic flows f₁-f₃ having a plurality of packets by way of signal paths or input links 710-712. In an embodiment, a set of input queues 720a-c are coupled to input links 710-712 and switch 740 via signal paths 730-732. In an embodiments, input queues 720-722 receives and stores packets 720a-c, 721a and 722a-b, respectively. Packet 722c is illustrated as being transferred to network element 701, in particular input queue 722, via input link 712.

Packets are transferred from input queues 720-722 to output queues 760-762 by way of signal paths 730-732 and 750-752 as well as switch 740. In an embodiment, switch coordination 707 drives the switch 740 to determine a schedule for forwarding the packets in output queues 760-762. In an embodiment, switch coordination 707 drives switch 740 to select packets from input queues 720-722 in a LIFO service discipline, or in response to LIFO 640. Routing 706 is responsible for determining an optimal route for routing each traffic flow f₁-f₃, or packets of the traffic flows, in an embodiment. In an embodiment, output queue 760 stores packets 760a-b from traffic flow f₃, output queue 761 stores packets 761a-b from traffic flow f₁ and output queue 762 stores packet 762a from traffic flow f₂.

In an embodiment, LIFO 640 and DMWS 641 perform a LIFO-DMWS policy to output packets from output queues 760-762 to output links 770-772. For example, packet 761c is selected from output queue 761 that has the maximum scheduling weight as compared to the scheduling weights associated with output queues 761-762. Packet 761c was retrieved from the selected output queue 761 in a LIFO service discipline or output (or transferred) as the most recently stored packet in output queue 761 that includes packets 761a-b that were stored early than packet 761c in output queue 761.

In an embodiment, rate limiter 642 and rate estimator 643 operate similarly as described herein to perform a SR-LIFO-DMWS policy for packets in traffic flows f₁-f₃. For example, rate limiter 642 limits the rate of transfer of packets between input queues 720-722 and output queues 760-762.

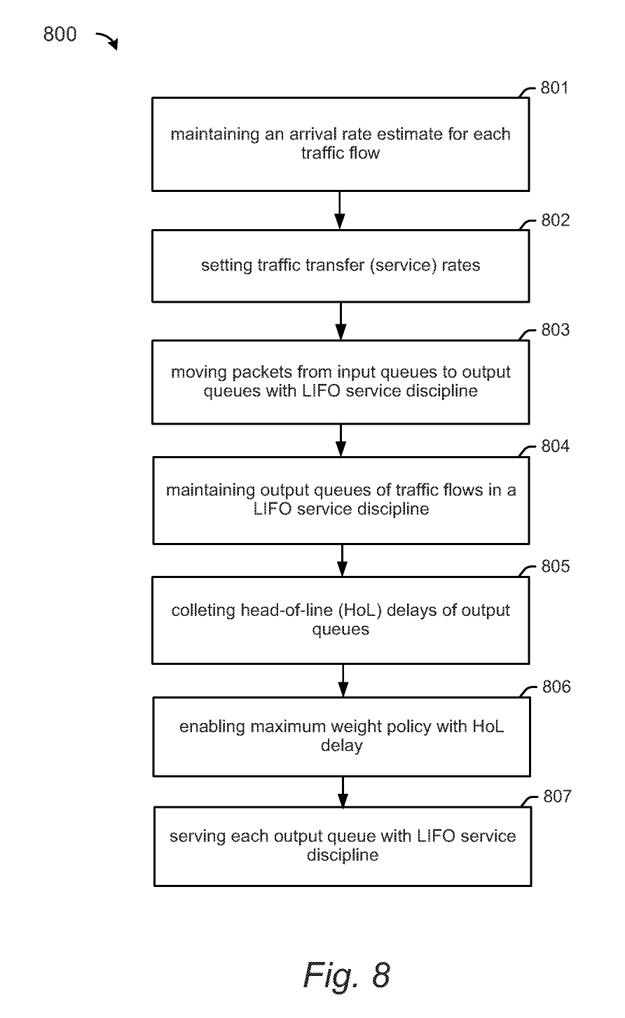

In embodiments, methods shown in FIGS. 8-13 are computer-implemented methods performed, at least partly, by hardware and/or software components illustrated in FIGS. 1-2 and 4-7 and as described herein. In an embodiment, software components executed by one or more processors, such as processor 633 shown in FIG. 1, perform at least a portion of the methods. In other embodiments, hardware components perform one or more functions described herein.

FIG. 8 is a flowchart that illustrates a method 800 of operating a network, such as a SDN, according to embodiments of the present technology. In FIG. 8 at 801 an arrival rate estimate for each traffic flow is maintained. In an embodiment, this function as well as the function at 802-807 are performed by one or more components illustrated in FIGS. 1-2 and 4-7. In embodiments, rate estimator 643 as shown in FIG. 6, executed by processor 633 performs at least a portion of this function.

At 802 traffic transfer (or service) rates are set. In embodiments, rate limiter 642 as shown in FIG. 6, executed by processor 633 performs at least a portion of this function.

At 803 packets are moved from input queues, such as input queues 644a, to output queues, such as output queues 644b, with LIFO service discipline. In embodiments, LIFO 640 as shown in FIG. 6, executed by processor 633 performs at least a portion of this function as well as the function at 804 and/or 807.

At 804 output queues of traffic flows are maintained in a LIFO service discipline.

At 805 head-of-line (HoL) delays of output queues are collected. In embodiments, DMWS 641 as shown in FIG. 6, executed by processor 633 performs at least a portion of this function as well as the function at 806.

At 806 maximum weight policy with HoL delay is enabled.

At 807 each output queue is served with LIFO service discipline. In an embodiment, a packet from the selected output queue is output to a particular link in a LIFO service discipline.

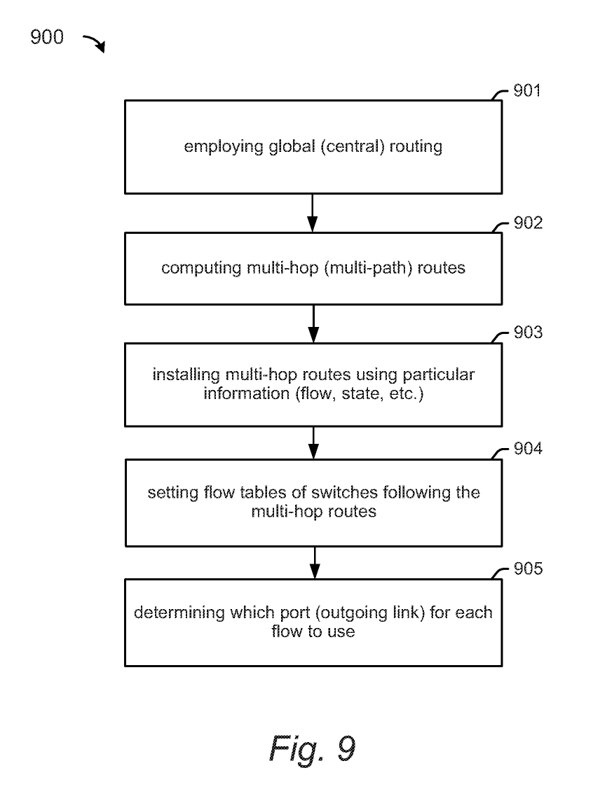

FIG. 9 is a flowchart that illustrate a method 900 of operating a network including a controller and switches according to embodiments of the present technology. In FIG. 9 at 901 global (central) routing is employed. In an embodiment, controller 190 performs this function (as well as other functions in method 900) by executing routing instructions by a controller processor to output control signals via signal paths to nodes (or switches) and links in network 100 as shown in FIG. 1.

At 902 multi-hop (multi-path) routes are computed.

At 903 multi-hop routes are installed using particular information (flow, state, etc.).

At 904 flow tables of switches are set following the multi-hop routes. In an embodiment, a switch performs this function in response to control signals from a controller.

At 905 a determination is made as to which port (outgoing link) for each flow to use. In an embodiment, a switch performs this function.

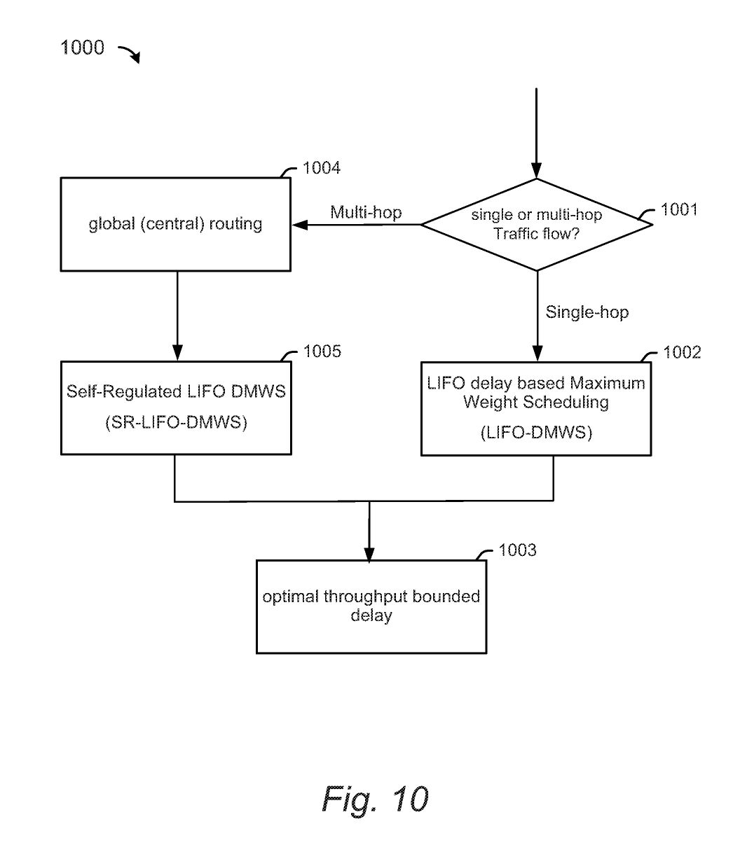

FIG. 10 is a flowchart that illustrate a method 1000 of operating a network having SR-LIFO-DMWS and/or LIFO-DMWS policy according to embodiments of the present technology. In embodiments, one or more components of network 100 perform one more function of method 1000. In FIG. 10 at 1001 a determination is made as to whether there is a single or multi-hop traffic flow. When a single-hop network is determined, control transfers to 1002. When a multi-hop network topology is determined, control transfers to 1004.

At 1002 LIFO a delay based maximum weight (LIFO-DMWS) policy is performed and control transfers to 1003.

At 1003 optimal throughput bounded delay is achieved.

At 1004, when a multi-hop is determined, global (central) routing is performed.

At 1005 a self-regulated LIFO DMWS (SR-LIFO-DMWS) scheduling policy is performed to achieve optimal throughput bounded delay at 1003.

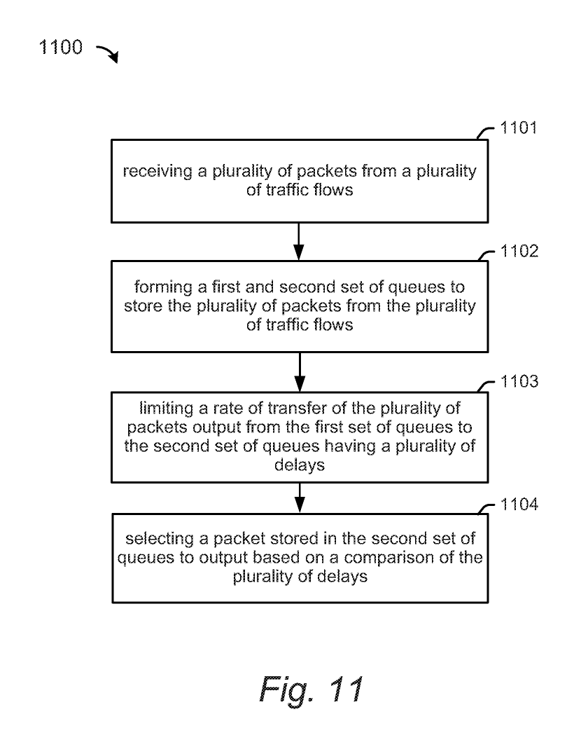

FIG. 11 is a flowchart that illustrate a method 1100 of scheduling a plurality of packets in a network according to embodiments of the present technology.

At 1101 a plurality of packets from a plurality of traffic flows is received. In embodiments, ports 220a-c and Tx/Rx 610a via signal path 660 as shown in FIG. 6, performs at least a portion of this function.

At 1102 a first and second set of queues are formed to store the plurality of packets from the plurality of traffic flows. In an embodiment, input queues 644a and output queues 644b are used.

At 1103 a rate of transfer of the plurality of packets output from the first set of queues to the second set of queues having a plurality of delays is limited. In embodiments, rate limiter 642 as shown in FIG. 6, executed by processor 633 performs at least a portion of this function.

At 1104 a packet stored in the second set of queues is selected to be output based on a comparison of the plurality of delays. In embodiments, LIFO 640 and DMWS 641 as shown in FIG. 6, executed by processor 633 performs at least a portion of this function.

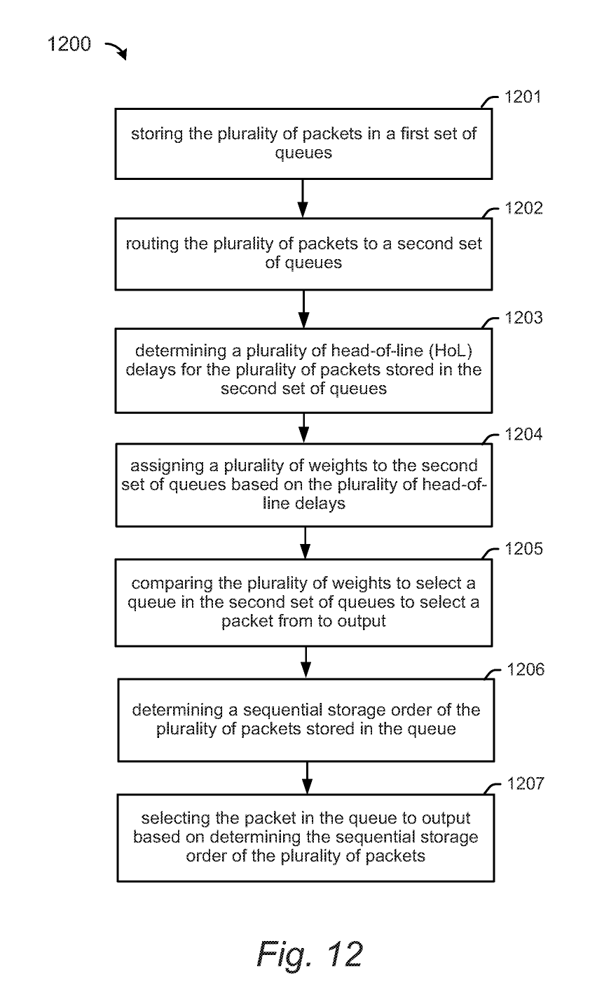

FIG. 12 is a flowchart that illustrate a method 1200 of scheduling a plurality of packets in a network using a SR-LIFO-DMWS policy according to embodiments of the present technology.

In FIG. 12 at 1201 the plurality of packets are stored in a first set of queues, such as input queues 644a.

At 1202 the plurality of packets are routed to a second set of queues. In an embodiment, routing 706 and switch coordination 707 performs this function.

At 1203 a plurality of head-of-line (HoL) delays for the plurality of packets stored in the second set of queues is determined. In embodiments, DMWS 641 as shown in FIG. 6, executed by processor 633 performs at least a portion of this function and/or the functions at 1204 and/or 1205.

At 1204 a plurality of weights is assigned to the second set of queues based on the plurality of head-of-line delays.

At 1205 each weight in the plurality of weights is compared to one another to select a queue in the second set of queues to select a packet from to be output.

At 1206 a sequential storage order of the plurality of packets stored in the selected queue is determined. In embodiments, LIFO 640 as shown in FIG. 6, executed by processor 633 performs at least a portion of this function and/or the function at 1207.

At 1207 the packet in the queue is selected to output based on determining the sequential storage order of the plurality of packets. In an embodiment, the packet is output in a LIFO service discipline. In an embodiment, a sequential storage order refers to a time sequence associated with packets stored in a queue. For example, when a first packet is stored at a first particular time in the queue and a second packet is stored at a second particular time in the queue that is later than the first particular time, the sequential storage order of the packets would be: first packet, second packet.

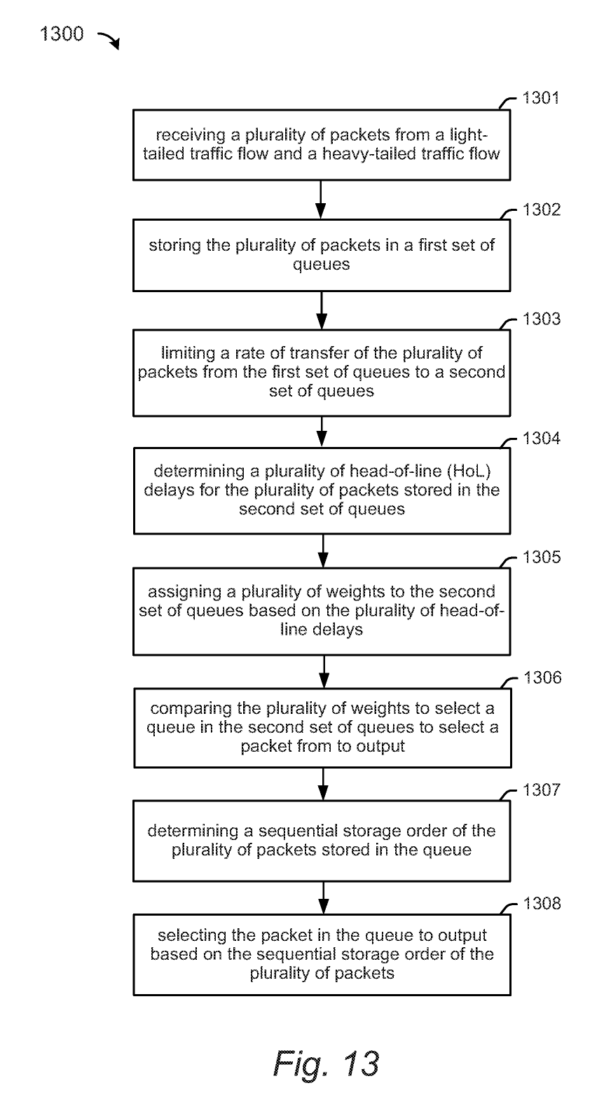

FIG. 13 is a flowchart that illustrates a method 1300 of scheduling a plurality of packets in a hybrid heavy-tailed/light-tailed (HT/LT) network according to embodiments of the present technology.

At 1301 a plurality of packets from a plurality of light-tailed and heavy-tailed traffic flows is received. In embodiments, ports 220a-c and Tx/Rx 610a via signal path 660 as shown in FIG. 6, performs at least a portion of this function.

At 1302 the plurality of packets is stored in a plurality of queues, such as input queues 644a.

At 1303 a rate of transfer of the plurality of packets from the first set of queues to a second set of queues is limited. In embodiments, rate limiter 642 as shown in FIG. 6, executed by processor 633 performs at least a portion of this function.

At 1304 a plurality of head-of-line (HoL) delays is determined for the plurality of packets stored in the second set of queues is determined. In embodiments, DMWS 641 as shown in FIG. 6, executed by processor 633 performs at least a portion of this function and/or the functions at 1305 and/or 1306.

At 1305 a plurality of weights is assigned to the second set of queues based on the plurality of head-of-line delays.

At 1306 each weight in th the plurality of weights is compared to one another to select a queue in the second set of queues to select a packet from to be output.

At 1307 a sequential storage order of the plurality of packets stored in the queue is determined. In embodiments, LIFO 640 as shown in FIG. 6, executed by processor 633 performs at least a portion of this function and/or the function at 1308.

At 1308 the packet in the queue is selected to be output based on the sequential storage order of the plurality of packets. In an embodiment, the packet is output in a LIFO service discipline.

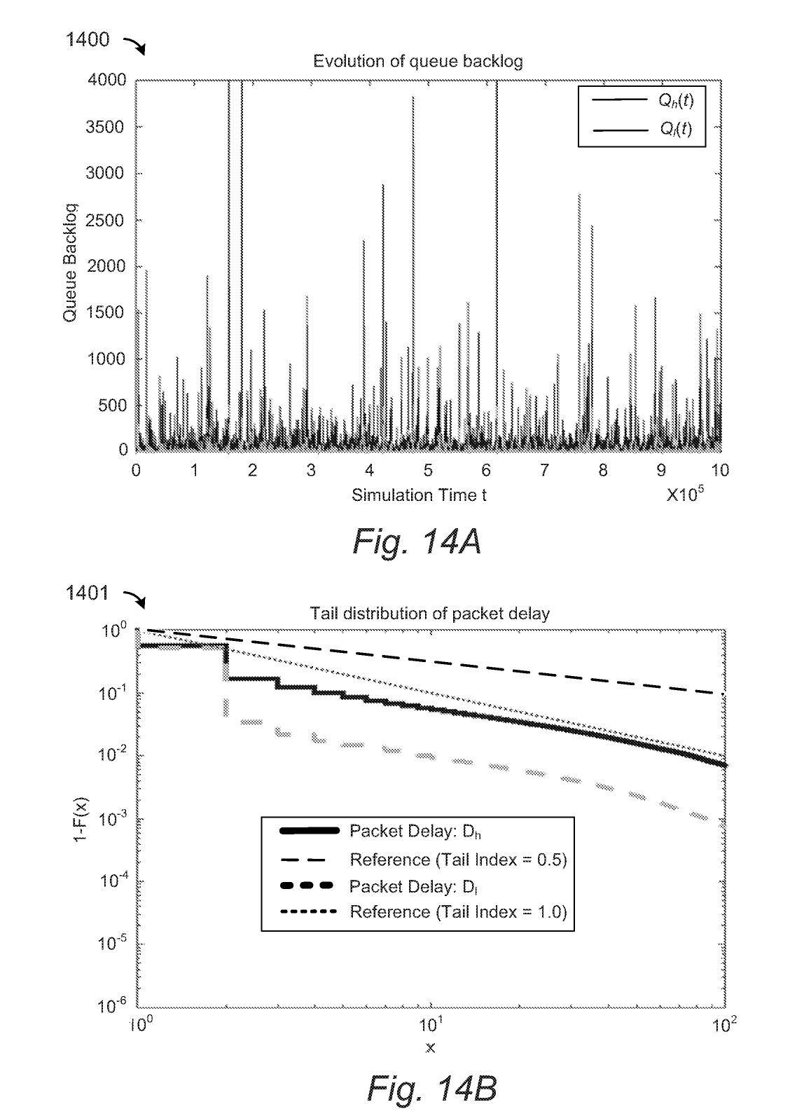

FIGS. 14A-B are graphs that illustrate scheduling a HT traffic flow and LT traffic flow according to embodiments of the present technology. In particular, FIGS. 14A-B illustrates that using a LIFO-DMWS scheduling policy enables both HT and LT traffic flows having bounded average delays. FIG. 14A illustrates a graph 1400 where there is no large queue backlog for LT traffic flows during evolution in an embodiment. FIG. 14B illustrates a graph 1401 where the delay tail distribution of both HT and LT traffic flows having a slope or decaying rate greater than 1 in an embodiment.

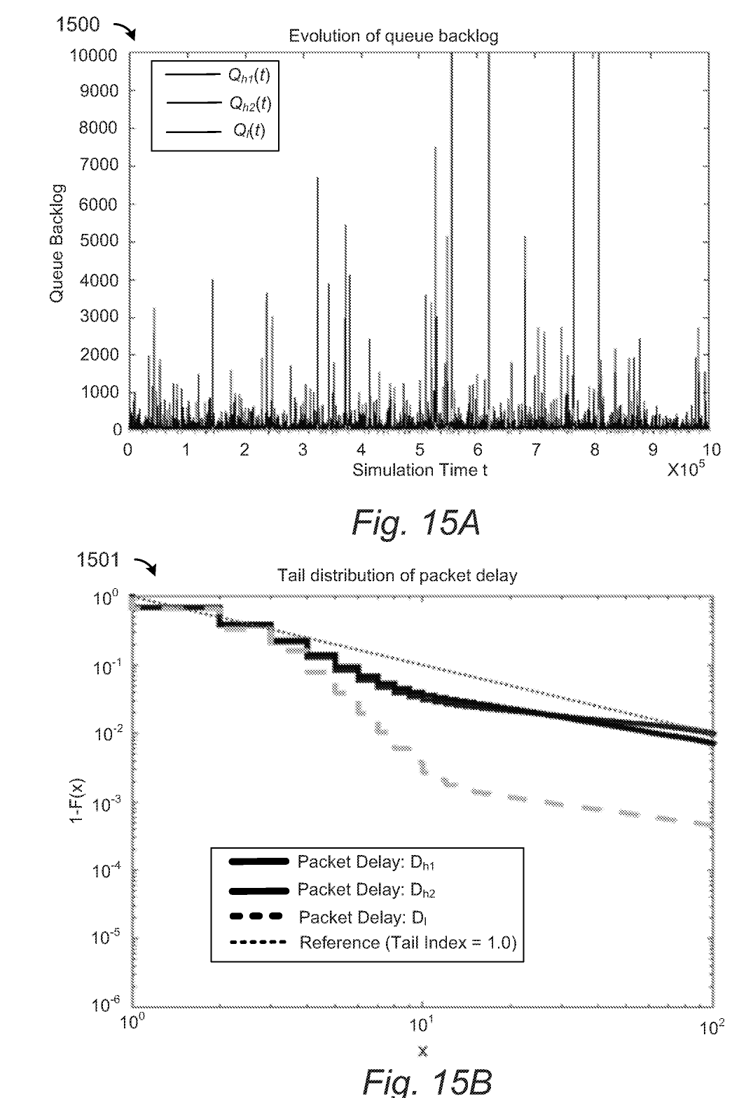

FIGS. 15A-B are graphs that illustrate scheduling two HT traffic flows and a LT traffic flow according to embodiments of the present technology. In an embodiment, two HT traffic flows and a LT traffic flow have bounded average delays using a LIFO-DMWS policy. FIG. 15A illustrates a graph 1500 where there is no large queue backlog for LT traffic flows during evolution in an embodiment. FIG. 15B illustrates a graph 1501 where the delay tail distribution of all HT and LT traffic flows have a decaying rate greater than 1 to ensure finite mean of packet delay and a stable SDN in an embodiment.

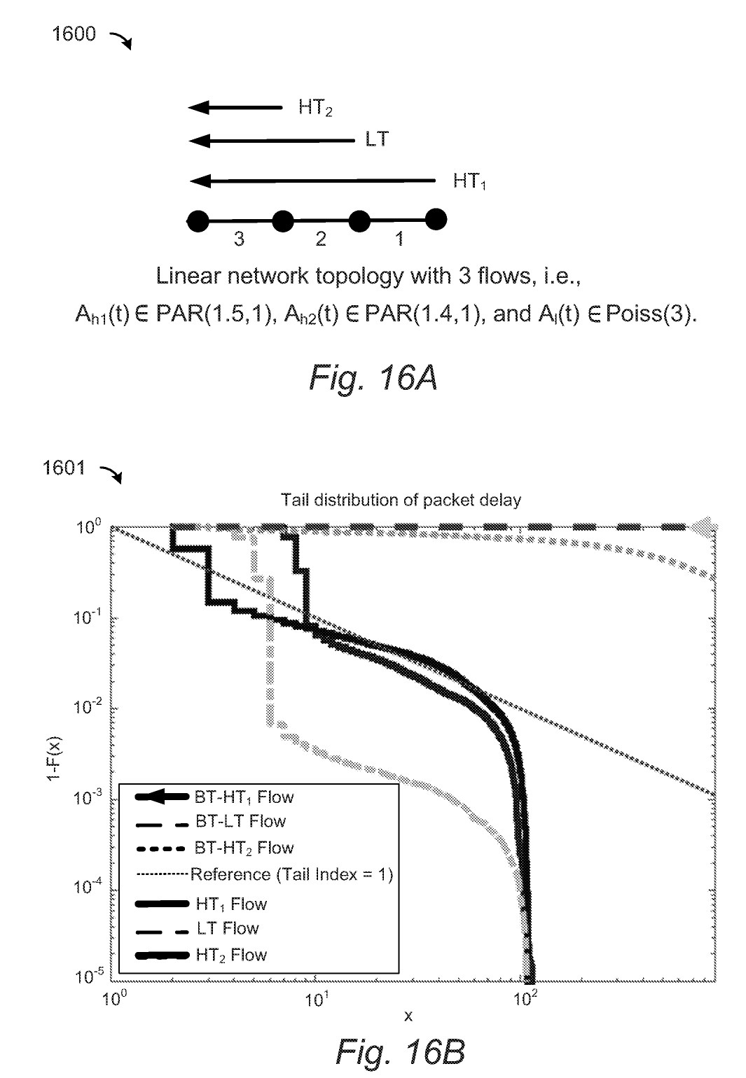

FIG. 16A illustrates a linear network topology having three traffic flows in a multi-hop network according to embodiments of the present technology. A linear multi-hop network topology 1600 is used to compare a SR-LIFO-DMWS scheduling policy with a back pressure (BP) routing policy.

FIG. 16B is a graph that illustrates a comparison between a BP routing policy and a SR-LIFO-DMWS policy according to embodiments of the present technology. Graph 1601 illustrates that with BP routing, tail distribution of each flow decays much slower than the reference line (indicating all flows have infinite queueing delay). Using a SR-LIFO-DMWS policy, graph 1601 indicates all traffic flows have a finite end-to-end delay.

Returning to FIG. 1, controller 190 includes a user interface that may include computer instructions that may be executed by the processor of controller 190 as well as additional hardware components in embodiments. A user interface may include input devices such as a touchscreen, microphone, camera, keyboard, mouse, pointing device and/or position sensors. Similarly, a user interface may include output devices, such as a display, vibrator and/or speaker, to output images, characters, vibrations, speech and/or video as an output. A user interface may also include a natural user interface where a user may speak, touch or gesture to provide input. In embodiments, a user interface may be used to control or provide inputs to a SR-LIFO-DMWS or LIFO-DMWS policy as described herein.

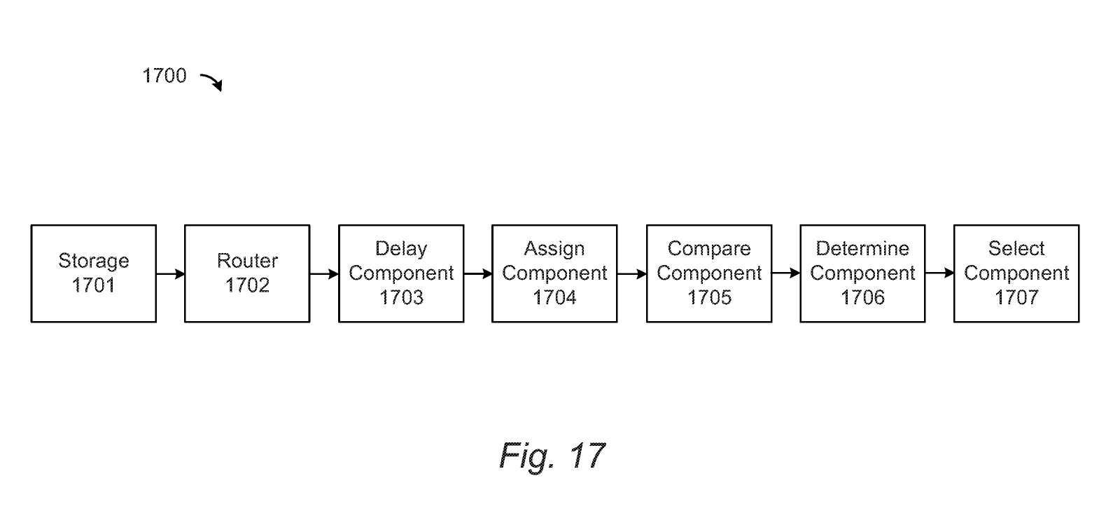

FIG. 17 is a block diagram of a packet scheduler 1700 according to embodiments of the present technology. A packet scheduler 1700 schedules a plurality of packets from a plurality of traffic flows. The packet scheduler comprises storage 1701 to store the plurality of packets in a first set of queues. A router 1702 routes the plurality of packets to a second set of queues. A delay component 1703 determines a plurality of head-of-line (HoL) delays for the plurality of packets stored in the second set of queues. An assign component 1704 assigns a plurality of weights to the second set of queues based on the plurality of head-of-line delays. A compare component 1705 compares the plurality of weights to select a queue in the second set of queues to select a packet from to output. A determine component 1706 determines a sequential storage order of the plurality of packets stored in the selected queue. A select component 1707 selects the packet in the selected queue to output based on a determination of the sequential storage order of the plurality of packets. In embodiments, delay component 1703, assign component 1704, compare component 1705, determine component 1706 and select component 1707 may include software and/or hardware components as described herein. Similarly, storage 1701 may include memory as described herein and router 1702 may include a router as described herein.

Advantages of the present technology may include, but are not limited to, providing a fully distributed network stable policy that enables reliable scheduling/routing. In particular, the policy addresses HT traffic in multi-hop SDNs. In embodiments, a delay-optimal policy may be used for all types of traffic. Hybrid traffic flows, such as HT and LT traffic flows, may have a bounded delay when sharing a scheduler. The present technology provides a self-regulated LIFO scheduling with throughput optimality, bounded latency and network stability.

The present technology provides traffic-aware a LIFO-DMWS policy that controls the switch scheduling of hybrid HT and LT traffic flows for throughput optimality with little packet delay in embodiments.

The present technology provides a SR-LIFO-DMWS policy as a fully distributed network stable policy that self-regulates switches with two-stage structure, SR-LIFO and LIFO-DMWS policy, to yield network stability for congestion-free SDNs without requiring signaling in embodiments.

A further advantage of the present technology includes applicability to generic large-scale SDNs with different traffic statistics due to low computational and implementation complexities in embodiments.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or network element), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a system, a device (network element) having one or more processors executing instructions stored in non-transitory memory, a computer-implemented method, and/or a non-transitory computer-readable storage medium storing computer instructions.

Non-transitory computer-readable media includes all types of computer-readable media, including magnetic storage media, optical storage media, and solid state storage media and specifically excludes signals. It should be understood that software including computer instructions can be installed in and sold with a computing device (network element) having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable medium include the following: a portable computer diskette, a hard disk, a random access memory (RAM), ROM, an erasable programmable read-only memory (EPROM or Flash memory), an appropriate optical fiber with a repeater, a portable compact disc read-only memory (CD-ROM), an optical storage device, a magnetic storage device, or any suitable combination thereof.

Non-transitory computer instructions used in embodiments of the present technology may be written in any combination of one or more programming languages. The programming languages may include an object oriented programming language such as Java, Scala, Smalltalk, Eiffel, JADE, Emerald, C++, CII, VB.NET, Python, R or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may be executed entirely on the user's computer (or network element), partly on the user's computer, as a stand-alone software package, partly on the user's computer and partly on a remote computer (network controller), or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Although the subject matter has been described in language specific to structural features and/or methodological steps, it is to be understood that the subject matter defined in the appended claims is not necessarily limited to the specific features or steps (acts) described above. Rather, the specific features and steps described above are disclosed as example forms of implementing the claims.

What is claimed is:

1. An apparatus comprising:
a receiver to receive a plurality of packets from a plurality of traffic flows;
a first non-transitory memory to form a first and second set of queues to store the plurality of packets from the plurality of traffic flows;
a second non-transitory memory to store instructions; and
one or more processors in communication with the first and second non-transitory memories, wherein the one or more processors execute the instructions to:
limit a rate of transfer of the plurality of packets that is output from the first set of queues to the second set of queues having a plurality of delays; and
select a packet stored in the second set of queues to output based on a comparison of the plurality of delays.

2. The apparatus of claim 1, wherein select the packet includes:
determine a plurality of head-of-line (HoL) delays for the second set of queues, wherein a HoL delay in the plurality of HoL delays is a time duration between an arrival time and a transmission time of the packet in each queue of the second set of queues; and,
set a plurality of scheduling weights to the plurality of HoL delays.

3. The apparatus of claim 2, wherein select the packet includes
compare the plurality of scheduling weights for the second set of queues to select the packet from a queue having a largest delay.

4. The apparatus of claim 3, wherein the queue is last-in, first-out (LIFO) queue in which the packet is a latest packet stored in the LIFO queue.

5. The apparatus of claim 1, wherein the plurality of traffic flows include light-tailed traffic flows and heavy-tailed traffic flows, wherein the light-tailed traffic flows and heavy-tailed traffic flows have bounded delays, and wherein the apparatus is included in a cellular network.

6. The apparatus of claim 1, further comprising: a network controller coupled to a rate limiter,
wherein the rate limiter limits the rate of transfer of the plurality of packets that is output from the first set of queues to the second set of queues in response to a control signal from the network controller.

7. The apparatus of claim 6, further comprising:
a switch fabric to receive the packet from the rate limiter.

8. The apparatus of claim 6, wherein the first set of queues and the rate limiter is included in a first node of a multi-hop software-defined network, wherein the second set of queues is included in a second node of the multi-hop software-defined network, and further comprising:
a transmitter to output the packet to a destination in the multi-hop software-defined network.

9. A computer-implemented method to schedule a plurality of packets from a plurality of traffic flows, the method comprising:
storing the plurality of packets in a first set of queues;
routing the plurality of packets to a second set of queues;
determining a plurality of head-of-line (HoL) delays for the plurality of packets stored in the second set of queues;
assigning a plurality of weights to the second set of queues based on the plurality of head-of-line delays;
comparing the plurality of weights to select a queue in the second set of queues to select a packet from to output;
determining a sequential storage order of the plurality of packets stored in the queue; and
selecting the packet in the queue to output based on determining the sequential storage order of the plurality of packets.

10. The computer-implemented method of claim 9, wherein a head-of-line delay in the plurality of head-of-line delays includes a time duration between an arrival time and a transmission time of the packet in the queue and, wherein selecting the packet includes selecting the packet that is stored last in the queue.

11. The computer-implemented method of claim 10, further comprising:
limiting a rate of transfer the plurality of packets from the first set of queues to the second set of queues in response to a control signal.

12. The computer-implemented method of claim 11, wherein the control signal is received from a network controller, and wherein the control signal indicates an initial rate of transfer.

13. The computer-implemented method of claim 10, wherein the plurality of traffic flows include a light-tailed traffic flow and a heavy-tailed traffic flow.

14. The computer-implemented method of claim 13, wherein the light-tailed traffic flow and the heavy-tailed traffic flow have bounded delays, and wherein the computer-implemented method is performed at least partially by a multi-hop cellular network.

15. A non-transitory computer-readable medium storing computer instructions, that when executed by one or more processors, cause one or more processors to perform the steps of:
receive a plurality of packets from a light-tailed traffic flow and a heavy-tailed traffic flow;
store the plurality of packets in a first set of queues;
limit a rate of transfer of the plurality of packets from the first set of queues to a second set of queues;
determine a plurality of head-of-line (HoL) delays for the plurality of packets stored in the second set of queues;
assign a plurality of weights to the second set of queues based on the plurality of head-of-line delays;
compare the plurality of weights to select a queue in the second set of queues to select a packet from to output;
determine a sequential storage order of the plurality of packets stored in the queue; and
select the packet in the queue to output based on the sequential storage order of the plurality of packets.

16. The non-transitory computer-readable medium of claim 15, wherein a head-of-line delay in the plurality of head-of-line delays includes a time duration between an arrival time and a transmission time of the packet in the plurality of packets in the queue.

17. The non-transitory computer-readable medium of claim 16, further comprising:
transfer the packet from the queue to a destination in a software-defined network.

18. The non-transitory computer-readable medium of claim 17, wherein the queue is a last-in, first-out (LIFO) queue and the packet is stored last in the LIFO queue.

19. The non-transitory computer-readable medium of claim 18, wherein the software-defined network includes a cellular network that transfers the light-tailed traffic flow and heavy-tailed traffic flow.

20. The non-transitory computer-readable medium of claim 19, wherein the light-tailed traffic flow and the heavy-tailed traffic flow have bounded delays.
